(19) United States
(12) Patent Application Publication
(10) Pub. No.: US 2011/0084238 A1
(43) Pub. Date: Apr. 14, 2011

(54) PROCESS FOR PREPARING LITHIUM VANADIUM OXIDES AND THEIR USE AS CATHODE MATERIAL

(75) Inventors: Hartmut Hibst, Schriesheim (DE); Kirill Bramnik, Dossenheim (DE); Julian Proelss, Worms (DE)

(73) Assignee: BASF SE, Ludwigshafen (DE)

(21) Appl. No.: 12/995,291

(22) PCT Filed: May 28, 2009
(86) PCT No.: PCT/EP2009/056520

§ 371 Date: Nov. 30, 2010

(30) Foreign Application Priority Data
May 30, 2008 (EP) 08157361.0

(51) Int. Cl. H01B 1/02; B32B 5/16; B29B 9/00; C01G 31/02; H01M 4/90; H01B 1/04; H01B 1/12; B82Y 30/00

(52) U.S. Cl. 252/506; 428/402; 264/5; 423/594.8; 252/182.1; 252/520.4; 252/519.33; 252/519.1; 977/742

(57) ABSTRACT

The present invention relates to a process for preparing lithium vanadium oxides and also a process for producing mixtures of a lithium vanadium oxide and at least one electrically conductive material. Furthermore, the invention relates to the use of lithium vanadium oxides or of mixtures of a lithium vanadium oxide and at least one electrically conductive material for producing cathodes for batteries and in electrochemical cells. In addition, the invention relates to cathodes which comprise a lithium vanadium oxide or a mixture of a lithium vanadium oxide and at least one electrically conductive material.

The present invention relates to a process for preparing lithium vanadium oxides and also a process for producing mixtures of a lithium vanadium oxide and at least one electrically conductive material. Furthermore, the invention relates to the use of lithium vanadium oxides or of mixtures of a lithium vanadium oxide and at least one electrically conductive material for producing cathodes for batteries and in electrochemical cells. In addition, the invention relates to cathodes which comprise a lithium vanadium oxide or a mixture of a lithium vanadium oxide and at least one electrically conductive material.

In an increasingly mobile society, portable electric appliances are playing an ever greater role. For many years, rechargeable batteries have been used in virtually all areas of daily life. In the development of new types of battery systems, there is particular interest in being able to produce rechargeable batteries which have a high measure of safety in use together with a high specific capacity in an inexpensive fashion. In addition, their temperature and shock sensitivity and their self-discharging rate should be low. Furthermore, a very large number of charging and discharging cycles should be possible without a loss of capacity (i.e. high cyclability), as a result of which the product life of the battery can be increased.

The anode of a modern high-energy lithium ion battery nowadays typically comprises graphite but it can also be based on metallic lithium, a lithium alloy or a lithium compound. The use of lithium cobalt oxide has in recent years been found to be useful for the construction of the cathode of a modern lithium ion battery.

The two electrodes are connected using a liquid or solid electrolyte in a lithium ion battery. Possible liquid electrolytes are, in particular, nonaqueous electrolytes and molten salts. As solid electrolytes, it is possible to use, for example, ionically conductive polymers.

When a lithium ion battery having a lithium vanadium oxide cathode is used (discharge), lithium ions migrate into the layer structure of the lithium vanadium oxide from which they can be removed again during charging. During discharge of the battery, lithium of the anode is oxidized to lithium ions which then migrate through the electrolyte to the cathode. When a lithium ion battery is recharged, reduction of the lithium ions occurs at the anode. Both during discharge and during recharging of the battery, the lithium ions generally migrate through a separator.

To enable a battery to be used for a long time, not only the anode and the electrolyte but also the cathode have to have a high chemical and electrochemical stability. Since the ability of the lithium vanadium oxide having a layer structure to take up and release ions is of greater importance for the stability and also the capacity of the cathode, it is an important object to develop new types of lithium vanadium oxides which, as a result of this structure, make long-term reversible migration of lithium ions into and out of the electrode possible.

Since the crystal structure of lithium vanadium oxides having the formula Li₁₊ₓV₃O₈ (where x is from 0 to 0.6) was for the first time described in detail about 50 years ago (A. D. Wadsley, Acta Cryst. 1957, Vol. 10, pp. 261-7), numerous groups of workers worldwide have addressed the use of lithium vanadium oxides for the construction of electrochemical cells. Thus, for example, U.S. Pat. No. 3,929,504 described, as early as 1975, the structure of a rechargeable battery comprising a lithium anode and an electrolyte material and also a cathode comprising vanadium pentoxide. Later, U.S. Pat. No. 3,970,473 described Li_{0.33}V₂O₅ and U.S. Pat. No. 5,013,620 described Li_{1.1}V₃O₈ as cathode materials. A lithium vanadium oxide of the formula Li_{1.1}V₃O₈ having particularly favourable electrochemical properties has been described by Bramnik et al. (Bramnik, K. G. et al., “Li₁₊ₓV₃O₈: Neues Kathodenmaterial mit alkbekannter Struktur für Lithium-Batterien”, paper at the 17^{th} Diskussionstagung Anorganisch-Teschnische Chemie in Frankfurt/Main, Feb. 28-29, 2008).

Lithium vanadium oxides, in particular Li₁₊ₓV₃O₈ (where x is from 0 to 0.6), can be prepared by a large number of known methods. For example, a lithium compound can be heated together with vanadium pentoxide to a temperature of about 750° C., resulting in formation of a melt composition which is subsequently ground to a powder. It is also possible to prepare lithium vanadium oxides using liquids.

For example, U.S. Pat. No. 5,039,582 describes a process for preparing amorphous lithium vanadium oxide starting out from a suspension of vanadium pentoxide, lithium hydroxide and water. The product which forms a precipitate can then be dried at elevated temperature and used.

The use of other auxiliaries in the preparation of lithium vanadium oxides is also described in the literature; for example, U.S. Pat. No. 5,549,880 uses a dispersion of lithium hydroxide in alcohol to which vanadium pentoxide is subsequently added.

WO 01/22507 proposes the use of an organic solvent for carrying out the process for preparing lithium vanadates, but a complicated filtration process becomes necessary.

U.S. Pat. No. 5,520,903 describes a dry process in which a lithium compound such as lithium hydroxide and a vanadium compound such as vanadium pentoxide are mixed, subsequently pressed and then heated to a temperature of at least 570° C.

U.S. Pat. No. 6,136,476 describes a process in which the product formed by calcination is comminuted by means of an air jet in order to obtain a homogeneous particle size.

The US patent application 2005/0026041 describes lithium vanadium oxides which are prepared by pulverization of vanadium oxide and lithium carbonate with subsequent calcination at 580° C. for 10 hours. The construction of a lithium ion battery and the testing of the cathode stability are also described in detail in this document. This document is therefore expressly incorporated by reference.

Many further processes for preparing lithium vanadium oxides which comprise the essential process steps of mixing of the components, comminution or milling of the intermediate obtained and subsequent calcination are known. However, many of the known processes cannot be carried out on an industrial scale or lead to a process product which is not suitable for producing high-performance and durable cathodes.

It was an object of the present invention to provide an improved process for preparing lithium vanadium oxides, in particular Li₁₊ₓV₃O₈ (where x is from 0 to 0.6), which is technically simple to carry out and makes it possible to produce a stable cathode material for lithium ion batteries in relatively large amounts and in a reproducible process. A further object of the present invention was to provide a material which, owing to a homogeneous particle size, can be processed further without complicated purification and separation steps to produce cathodes.

The object of the invention is achieved by a process for preparing lithium vanadium oxides, in particular Li₁₊ₓV₃O₈ (where x is from 0 to 0.6), in which a solution or suspension is firstly produced from water, at least one water-soluble lithium salt, at least one water-soluble vanadium compound and, if appropriate, further components, this solution or suspension is subjected to a drying process and a calcination step is subsequently carried out.

The invention accordingly provides a process for preparing lithium vanadium oxides, which comprises the steps:
a) production of a solution or suspension from water, at least one water-soluble lithium salt, at least one water-soluble vanadium compound and, if appropriate, further components, with it also being possible for at least the lithium salt and the vanadium compound to be present in completely dissolved form in the suspension,
b) drying of the solution or suspension produced in step a), and
c) calcination of the solid obtained in step b).

As lithium salts, it is possible to use all ionic lithium compounds having a sufficient solubility in water, for example lithium oxide, lithium hydroxide (and its hydrate), lithium nitrate, lithium carbonate and also organic lithium salts such as lithium acetate, lithium formate, lithium oxalate, lithium citrate, lithium lactate, lithium tartrate or lithium stearate. However, preference is given to using lithium hydroxide, lithium acetate or lithium carbonate or a mixture of these salts as lithium salt. Lithium hydroxide has been found to be particularly useful.

As vanadium compound, it is possible to use, first and foremost, vanadium compounds having a sufficient solubility in water, for example ammonium metavanadate (NH₄VO₃), ammonium polyvanadate, vanadium(IV) salts such as vanadyl sulfate (VO(SO₄)), vanadium(V) salts such as sodium vanadate (Na₃VO₄) or mixtures and/or hydrates thereof. Ammonium metavanadate (NH₄VO₃) has been found to be particularly useful, but it is also possible to use ammonium metavanadate in combination with other vanadium compounds. Naturally, insoluble or sparingly water-soluble vanadium compounds such as vanadium pentoxide, vanadic acid, vanadium sesquioxide, vanadium dioxide or vanadium trioxide can also be used as starting materials if they can be converted into a soluble form, for example by treatment with acids, alkalis or ammonia.

Lithium salts and vanadium compounds are preferably used in such a stoichiometric ratio that the molar ratio of lithium to vanadium is from about 1:1.5 to 1:4, but preferably from about 1:1.8 to 1:3.5, in particular from 1:2 to 1:3.

The dissolution of the lithium salt and the vanadium compound in water is preferably carried out at a temperature of from 20 to 100° C., in particular from 50 to 95° C., preferably using a stirrer. A clear solution without turbidity is preferably formed here.

The solutions or suspensions produced generally comprise from 0.05 to 1.0 mol/l, preferably from 0.1 to 0.5 mol/l, of lithium and from 0.1 to 1.3 mol/l, preferably from 0.2 to 1.0 mol/l, of vanadium in dissolved form. An upper limit may be imposed on the lithium and vanadium concentrations by the solubility of the lithium salts and vanadium compounds used in water.

It is also possible to use, if appropriate, further components for producing the solution or suspension described in step a), which further components are, for example, incorporated as dopant into the crystal lattice of the lithium vanadium oxide during subsequent calcination or lead to a multiphase crystal microstructure having advantageous electrochemical properties. Possible further components are, for example, alkali metal salts (e.g. sodium hydroxide, potassium hydroxide, sodium carbonate, sodium hydrogen carbonate, potassium carbonate, potassium hydrogen carbonate), ammonia, silicon dioxide, magnesium oxide, antimony trioxide, bismuth trioxide, aluminum phosphate, ammonium molybdate, ammonium tungsten, starch, cellulose, carbohydrates or complexing agents (e.g. ethylenediaminetetraacetic acid (EDTA) or nitrilotriacetic acid (NTA)). The further components used are preferably likewise water-soluble.

Preference is given to starting out from a solution produced from water, lithium hydroxide and ammonium metavanadate and also, if appropriate, further water-soluble components. Greater preference is given to starting out from a clear aqueous solution produced from water, 0.05-0.5 mol/l, in particular 0.1-0.5 mol/l, of lithium hydroxide and 0.1-1.3 mol/l, in particular 0.2-1.0 mol/l, of ammonium metavanadate and, if appropriate, further water-soluble components. It is also possible to start out from a clear aqueous solution produced from water, 0.05-0.5 mol/l of lithium hydroxide, 0.1-1.3 mol/l of ammonium metavanadate and one or more compounds from the group consisting of alkali metal salts, preferably alkali metal hydroxides, and/or ammonia. In this way, alkali-metal-doped lithium vanadium oxides of the general formula Li_{1+x-y}M_{y}V₃O₈, where x is from 0 to 0.6, M is sodium, potassium, rubidium or cesium and y is from 0.05 to 0.5, preferably from 0.1 to 0.25, by means of the process of the invention.

In a further embodiment, a clear aqueous solution produced from water, 0.1-0.5 mol/l of lithium hydroxide, 0.2-1.0 mol/l of ammonium metavanadate and 0.001-0.2 mol/l of sodium hydroxide and/or 0.001-0.2 mol/l of potassium hydroxide is used as starting material. The solution described can be subjected directly to a spray drying process at a temperature of from 100 to 450° C., in particular from 100 to 300° C., using air or nitrogen.

In general, relatively dilute solutions or suspensions lead, after the process of the invention, to lithium vanadium oxides in the form of particularly finely divided spherical aggregates, while more concentrated solutions or suspensions lead to lithium vanadium oxides in the form of larger spherical aggregates.

In a preferred embodiment of the invention, the constituents of the solution or suspension, i.e. water, at least one water-soluble lithium salt, at least one water-soluble vanadium compound and, if appropriate, further components are stirred together for a period of from 0.1 to 24 hours, preferably from 0.5 to 10 hours, in particular from 1 to 3 hours, at a temperature of from 20 to 100° C., preferably from 50 to 95° C. At the end of the stirring time, the solutions or suspensions produced generally have a pH of from 3 to 13, preferably from 5 to 11 and particularly preferably from 6.5 to 9.5.

It is also possible to dissolve or, if appropriate, suspend the constituents of the solutions or suspensions according to the invention individually in water and combine the individual solutions and, if appropriate, suspensions only immediately before the drying step b), e.g. in a continuous process.

In process step b), the solution or suspension which has been produced is subjected to a drying process. In a preferred embodiment of the invention, this is, for example, spray drying. For this purpose, the aqueous solution or suspension is conveyed under pressure through a narrow nozzle (single-fluid or two-fluid nozzle), resulting in formation of very fine droplets which are dried by means of a stream of air or nitrogen. As an alternative, atomization can also be effected by means of a disk rotating at high speed. Preference is here given to using a stream of air or nitrogen having a temperature of from 100 to 450° C., in particular from 110 to 300° C. The spray drying process is preferably carried out directly using the solution or suspension without further intermediate steps. The spray drying process generally gives a solid having a mean particle size of <0.5 mm.

In a further embodiment of the invention, freeze drying, in particular freeze-spray drying, can also be carried out in process step b). Here, the atomized solution or suspension can, for example, be sprayed into liquid nitrogen and the spheres obtained can then be freed of water under reduced pressure at low temperature.

The solid obtained in process step b) can, if appropriate, be altered mechanically, e.g. milled, comminuted, tableted, compacted or kneaded, with auxiliaries also being able to be used in the steps mentioned. For example, the renewed use of water or organic, solid or liquid compounds to produce a slurry or a shapeable composition is possible.

The process step of calcination (step c)) can take place under any atmosphere, e.g. under an inert gas atmosphere (for example under nitrogen). Preference is given to using oxygen-comprising gas mixtures, in particular air. A temperature of from 250 to 600° C., preferably from 260 to 580° C., in particular from 280 to 500° C., very particularly preferably from 290 to 400° C., is preferably employed. Calcination at a temperature of from 295 to 350° C., in particular 315° C., has been found to be particularly useful. Calcination is, in particular, carried out for a period of from 0.2 to 12 hours, in particular from 0.5 to 10 hours. During calcination, heating to a temperature above 620° C. should be avoided where possible. The calcination step is preferably carried out under conditions (temperature, time, mixing, gas atmosphere) which are suitable for forming an essentially structurally uniform and water-free lithium vanadium oxide, in particular Li₁₊ₓV₃O₈ (where x is from 0 to 0.6). If ammonium salts have been used as starting materials for the process of the invention, the calcination step is preferably carried out under conditions which lead to a very low residual content of ammonium ions in the lithium vanadium oxide, for example with intensive replacement of the atmosphere above the material to be calcined. A residual content of ammonium ions in the lithium vanadium oxide of less than 3% by weight, preferably less than 1% by weight and particularly preferably less than 0.5% by weight, is advantageous.

It has been observed that the temperature of the calcination has a considerable influence on the specific surface area of the lithium vanadium oxide; lower temperatures generally result in products having a greater specific surface area. During calcination, the lithium vanadium oxide is preferably kept in motion, e.g. in a fluidized-bed reactor or a rotary tube furnace. The lithium vanadium oxide can also be stirred during the calcination. The motion makes rapid heat transport possible. Precisely this combination of conditions allows a great improvement in the reaction kinetics of the process compared to a fixed-bed process.

The heating step may, if appropriate, be followed by a cooling step in air, nitrogen or cooling at the natural cooling rate of the furnace.

The calcined solid obtained in process step c) can likewise be mechanically altered, e.g. milled, comminuted, tableted, compacted or kneaded, with auxiliaries also being able to be used in the steps mentioned, before it is used further. For example, the renewed use of water or organic, solid or liquid compounds for producing a slurry or a shapeable composition is possible.

The present invention also provides lithium vanadium oxides which can be prepared by the above-described process. These lithium vanadium oxides preferably have a specific surface area (measured by the BET method of Brunauer-Emmet-Teller) of from 0.5 to 50 m²/g, particularly preferably from 8 to 30 m²/g, in particular from 10 to 20 m²/g.

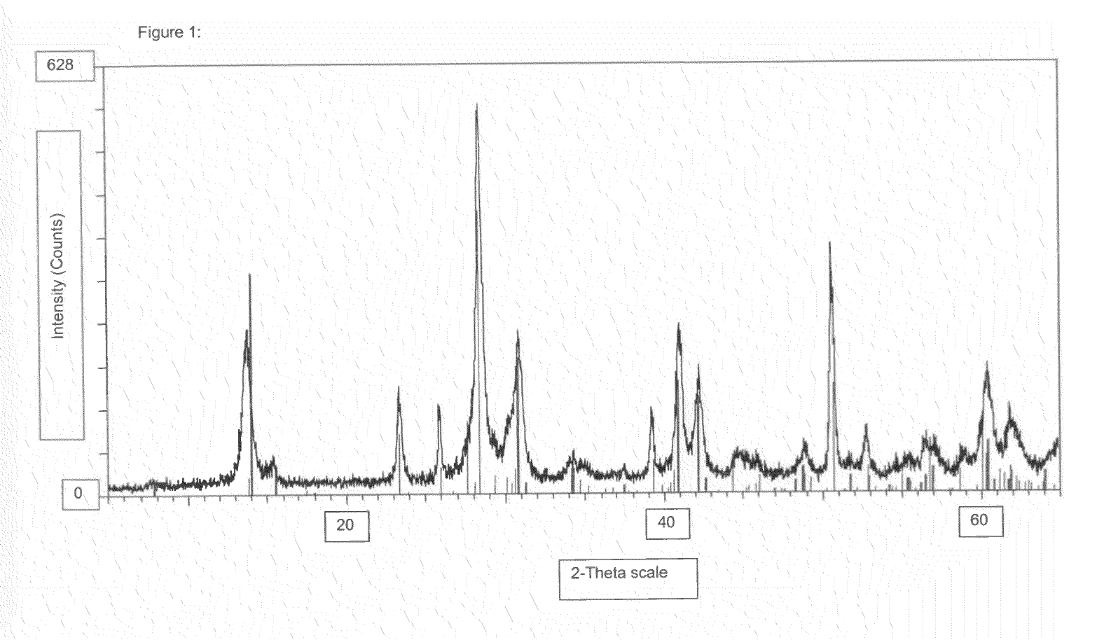

The lithium vanadium oxides of the invention preferably have a composition corresponding to the formula Li₁₊ₓV₃O₈ (where x is from 0 to 0.6). Preference is given to lithium vanadium oxides which do not have a distinct line in the 2 theta range from 27 to 28 degrees in an X-ray powder diffraction pattern recorded by means of copper K_{α} radiation. Particular preference is given to lithium vanadium oxides whose X-ray powder diffraction pattern corresponds essentially to one of those shown in FIGS. 1 to 3.

In a further preferred embodiment of the invention, the lithium vanadium oxides of the invention have a composition corresponding to the formula Li_{1+x-y}M_{y}V₃O₈, where x is from 0 to 0.6, M is sodium, potassium, rubidium or cesium and y is from 0.05 to 0.5, preferably from 0.1 to 0.25.

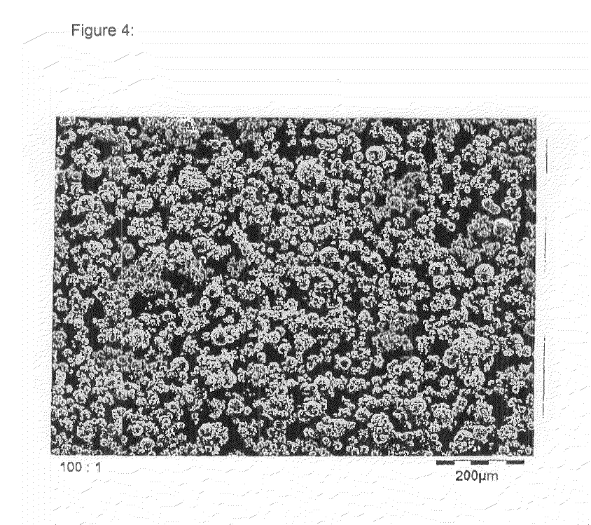

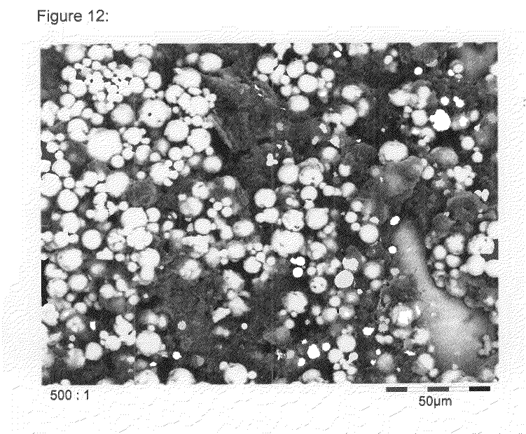

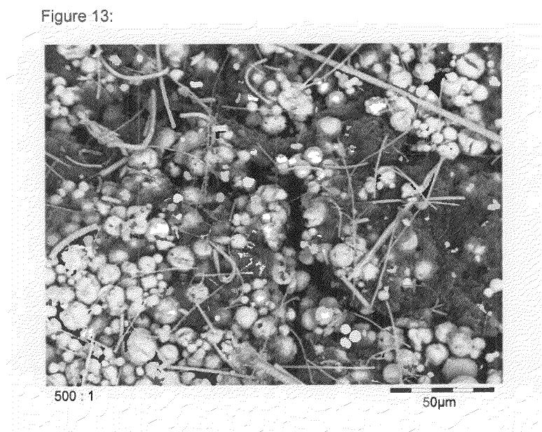

In a preferred embodiment of the invention, the lithium vanadium oxides of the invention form spherical aggregates which have a mean diameter of from 5 μm to 500 μm, in particular from 10 μm to 200 μm (see FIGS. 4, 5, 10, 11). These spherical aggregates can be used particularly advantageously for producing corresponding electrodes comprising lithium vanadium oxide for batteries since, owing to their isotropic electrical properties, they have no preferential transport direction for lithium ions which could possibly have an adverse effect on the electrochemical performance of the battery in the case of an unfavorable arrangement of the aggregates. The spherical shape of the aggregates is preferably also retained after their incorporation in an electrode (FIG. 12) and even after use of the electrode (FIG. 13).

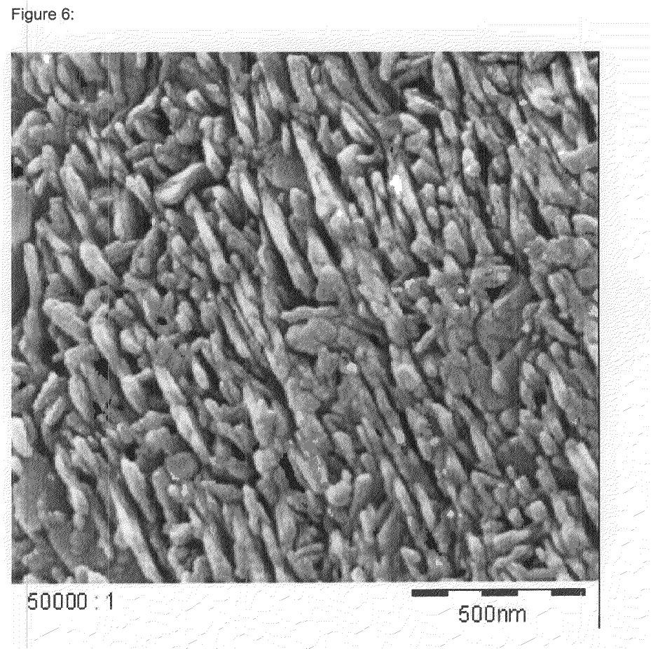

The aggregates of the calcined lithium vanadium oxides in spherical form preferably have a mean diameter of not more than 200 μm, with this mean diameter preferably being obtained without milling after calcination. These aggregates comprise a plurality of primary particles (see FIG. 6).

The present invention also provides for the use of the lithium vanadium oxides of the invention for producing a cathode for a battery, in particular a lithium ion battery. Furthermore, the invention provides a cathode for a lithium ion battery, which comprises a lithium vanadium oxide according to the invention.

To produce a cathode, the lithium vanadium oxide is preferably combined with at least one electrically conductive material, as described, for example, in WO 2004/082047.

Possible conductive materials are, for example, carbon black, graphite, carbon fibers, carbon nanofibers, carbon nanotubes or electrically conductive polymers. From about 2.5 to 40% by weight of the conductive material is typically used together with the lithium vanadium oxide in the cathode. For this purpose, the lithium vanadium oxide and the electrically conductive material are stirred together, if appropriate using an organic solvent and if appropriate an organic binder (e.g. polyisobutene), if appropriate shaped (e.g. spread out) and subsequently dried. The temperature used here is, for example, from 80 to 150° C. The drying process can also take place under reduced pressure and generally takes from 3 to 48 hours.

In a preferred embodiment of the invention, the electrically conductive material is added during the preparation of the lithium vanadium oxide by the process of the invention. This is preferably effected by adding the electrically conductive material before carrying out process step b) according to the invention, for example by combining a solution or suspension comprising water, at least one water-soluble lithium salt, at least one water-soluble vanadium compound and, if appropriate, further components with a separately prepared solution or suspension of the respective electrically conductive material. This leads to particularly intimate combination of the lithium vanadium oxide formed by the process of the invention with the electrically conductive material, which has an advantageous effect on the electrical properties of the cathode obtainable therefrom.

The invention therefore further provides a process for producing a mixture of a lithium vanadium oxide and at least one electrically conductive material, which comprises the steps:
a) production of a solution or suspension from water, at least one water-soluble lithium salt, at least one water-soluble vanadium compound, if appropriate further components and at least one electrically conductive material, with it also being possible for at least the lithium salt and the vanadium compound to be present in completely dissolved form in the suspension,
b) drying of the solution or suspension produced in step a), and
c) calcination of the solid obtained in step b).

The lithium salts, vanadium compounds, further components and electrically conductive materials to be used according to the invention correspond to the materials described above. The same applies to the apparatuses and parameters for the individual process steps.

In a preferred embodiment of the invention, a solution or suspension is produced from water, lithium hydroxide, ammonium metavanadate, if appropriate further components and at least one electrically conductive material in step a) of the process.

In a particularly preferred embodiment of the invention, a solution or suspension is produced from water, 0.05-0.5 mol/l of lithium hydroxide, 0.1-1.3 mol/l of ammonium metavanadate, if appropriate further components and at least one electrically conductive material in step a) of the process.

The electrically conductive material can be, for example, carbon black, graphite, carbon fibers, carbon nanofibers, carbon nanotubes or electrically conductive polymers.

If carbon black, graphite or other materials consisting essentially of carbon are used as electrically conductive materials for producing the solution or suspension described in step a) of the process of the invention, these are advantageously at least partly suspended in a solution or suspension of the other constituents. This can be achieved, for example, by direct addition while stirring of carbon black, graphite or other materials consisting essentially of carbon to water or a solution or suspension of one or more of the remaining constituents. As an alternative, carbon black, graphite or other materials consisting essentially of carbon can firstly be suspended in an aqueous hydrogen peroxide solution and the suspension obtained can be mixed with an aqueous solution of one or more of the other constituents. The treatment with hydrogen peroxide generally improves the wetability of the carbon by water and leads to aqueous carbon-comprising suspensions having increased stability, i.e. having a lower tendency to demix. In addition, the homogeneous dispersion of the carbon particles in the suspension is improved.

The solution or suspension according to the invention is preferably produced at a temperature of from 20 to 100° C., in particular from 50 to 95° C., using a stirrer.

This is then followed by drying of the solution or suspension produced in step a) of the process of the invention and calcination of the solid obtained.

To produce a cathode using the lithium vanadium oxides of the invention or the mixtures according to the invention of a lithium vanadium oxide and at least one electrically conductive material, the following polymeric materials in particular are possible as binders:

Polyethylene oxide (PEO), cellulose, polyethylene, polypropylene, polytetrafluoroethylene, polyacrylonitrile-methyl methacrylate, polytetrafluoroethylene, styrene-butadiene copolymers, tetrafluoroethylene-hexafluoroethylene copolymers, polyvinylidene difluoride-hexafluoropropylene copolymers (PVdF-HFP), tetrafluoroethylene-hexafluoropropylene copolymers, tetrafluoroethylene, perfluoroalkyl-vinyl ether copolymers, vinylidene fluoride-hexafluoropropylene copolymers, ethylene-tetrafluoroethylene copolymers, vinylidene fluoride-chlorotrifluoroethylene copolymers, ethylene-chlorofluoroethylene copolymers, ethylene-acrylic acid copolymers (with and without inclusion of sodium ions), ethylene-methacrylic acid copolymers (with and without inclusion of sodium ions), ethylene-methacrylic ester copolymers (with and without inclusion of sodium ions), polyimides and polyisobutene.

The binder is chosen, if appropriate, according to the properties of any solvent used. The binder is generally used in an amount of from 1 to 10% by weight, based on the total mixture of the cathode material. Preference is given to using from 2 to 8% by weight, in particular from 3 to 7% by weight.

The mixtures of a lithium vanadium oxide and at least one electrically conductive material which can be obtained by the process of the invention preferably have a specific surface area of from 0.5 to 50 m²/g, particularly preferably from 8 to 30 m²/g, in particular from 10 to 20 m²/g, and preferably form spherical aggregates having a diameter of from 5 μm to 500 μm, in particular from 10 μm to 200 μm.

The invention also provides for the use of the lithium vanadium oxides of the invention or the mixtures according to the invention of a lithium vanadium oxide and at least one electrically conductive material in electrochemical cells. These can have, for example, a prismatic thin film structure in which a solid thin film electrolyte is arranged between a film representing an anode and a film representing a cathode. A central cathode current collector is arranged between each of the cathode films in order to form a double-faced cell configuration.

In another embodiment, a single-faced cell configuration in which a single cathode current collector is assigned to a single anode/separator/cathode element combination can be used. In this configuration, an insulating film is typically located between individual anode/separator/cathode/current collector element combinations.

Regarding the figures:

FIG. 1 to FIG. 3 show the results of X-ray powder diffraction (XRD) for the products of Examples 1 to 3 (in each case calcined at 300° C.). The XRD was measured on an X-ray instrument “D4-Endeavor” from Bruker using Cu—K_{α} radiation at 2-theta from 5 degrees to 64 degrees in steps of 0.02 degree and an X-ray time of 3.6 seconds per step.

FIG. 4 shows the spherical lithium vanadium oxide particles from Example 1 (calcined at 300° C.) at a magnification of 100:1 (scanning electron micrograph (SEM)).

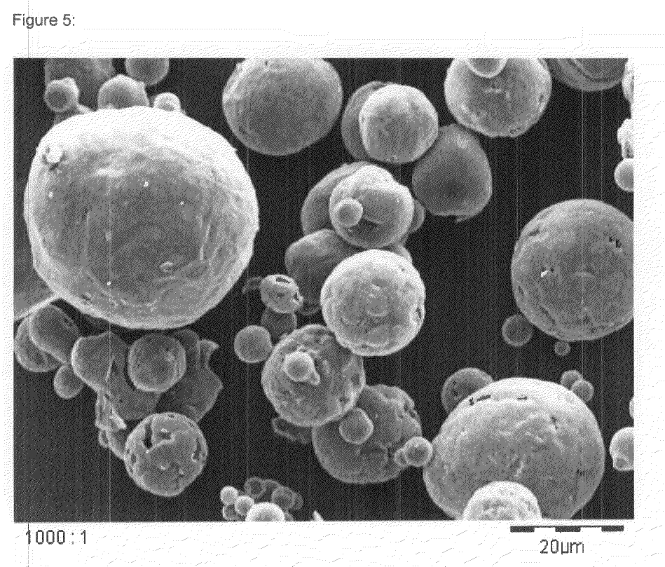

FIG. 5 shows the spherical lithium vanadium oxide particles from Example 1 (calcined at 300° C.) at a magnification of 1000:1 (SEM).

FIG. 6 shows the primary particles on the surface of a lithium vanadium oxide sphere from Example 1 (calcined at 300° C.) at a magnification of 50 000:1 (SEM).

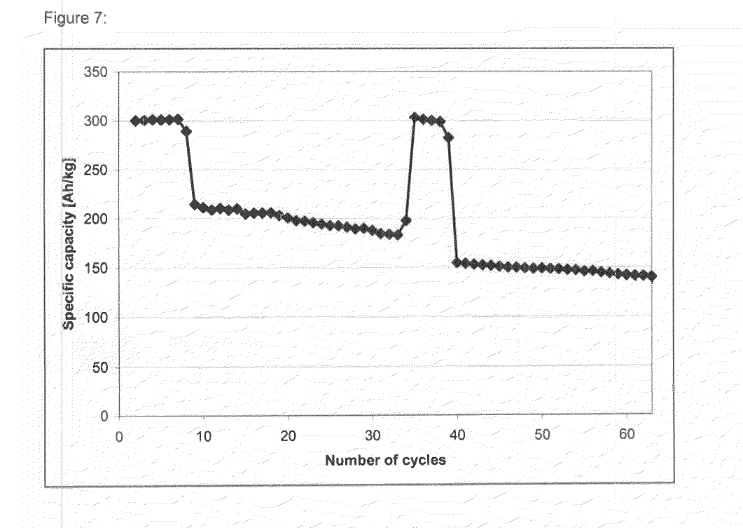

FIG. 7 to FIG. 9 show the results of stability tests using various lithium vanadium oxide cathodes in an electrochemical cell; in these figures, the specific charge capacity [in Ah/kg] is plotted against the number of cycles (for details, see Examples 5, 12 and 13).

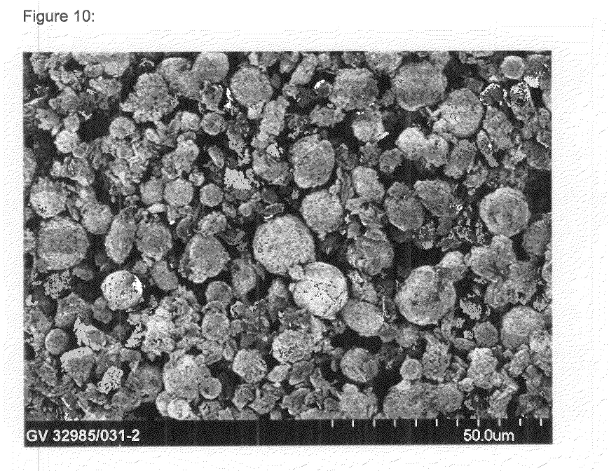

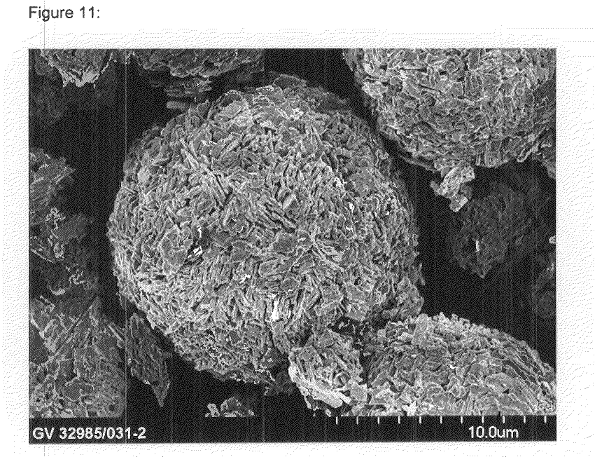

FIG. 10 and FIG. 11 show the spherical lithium vanadium oxide particles from Example 1 (calcined at 300° C.) at various magnifications (SEM).

FIG. 12 shows spherical lithium vanadium oxide particles together with carbon black and binder in an unused electrode at a magnification of 500:1 (SEM).

FIG. 13 shows spherical lithium vanadium oxide particles together with carbon black and binder in a used electrode at a magnification of 500:1 (SEM). The fibrous particles originate from the sample preparation.

The invention is illustrated by the following examples.

### EXAMPLE 1

### Preparation of Li_{1.1}V₃O₈

7.0 l of distilled water were heated to 90° C. in a 10 l stirred glass vessel equipped with a heatable double wall. 351.26 g of ammonium metavanadate NH₄VO₃ (99.9% by weight pure; corresponding to 3 mol; supplier: GfE GmbH, 90431 Nuremberg) and 47.47 g of lithium hydroxide LiOH.H₂O (having a content of 55.5% by weight of LiOH; corresponding to 1.1 mol, supplier: Chemetall GmbH, 60487 Frankfurt a. M.) were dissolved in succession with stirring in the initially charged water having a temperature of 90° C. to give a clear, yellow solution. The solution was stirred at a temperature of 90° C. for 15 hours (pH=8.0). The solution was spray dried using air (inlet temperature=330° C., outlet temperature=107° C.) in a spray drier (model: Mobile Minor™ 2000, MM, manufacturer: Niro NS, 2860 SØborg, Denmark).

50 g of the light-brown spray-dried powder obtained were heated to 300° C. under a stream of air (10 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The dark brown powder obtained had a specific surface area (measured by the BET method) of 13.3 m²/g. The powder diffraction pattern recorded using Cu—Kα radiation shows the presence of LiV₃O₈ (see FIG. 1). No line can be seen in the 2-theta range from 27 to 28 degrees. As scanning electron micrographs (SEM image, FIGS. 4 to 6) show, the product comprised agglomerates made up of small grown-together primary particles and having an average agglomerate diameter of about 20 μm. The ammonium (NH₄) content of the product was 0.34% by weight and the carbon content was <0.01% by weight.

Calcination of the spray-drying powder under a stream of air (45 standard l/h) at 315° C. for one hour gave a product having a specific surface area of 18.3 m²/g. The ammonium (NH₄) content of the product was 0.02% by weight and the carbon content was <0.01% by weight.

Calcination at 400° C. for one hour gave a product having a specific surface area of 11 m²/g, and calcination at a temperature of 500° C. gave a product having a specific surface area of 4.9 m²/g.

### EXAMPLE 2

### Preparation of Li_{1.0}Na_{0.1}V₃O₈

7.0 l of distilled water were heated to 90° C. in a 10 l stirred glass vessel equipped with a heatable double wall. 351.26 g of ammonium metavanadate NH₄VO₃ (99.9% by weight pure; corresponding to 3 mol) and 42.62 g of lithium hydroxide LiOH.H₂O (having a content of 55.5% by weight of LiOH; 1.0 mol) and 4 g of sodium hydroxide NaOH (0.1 mol, supplier: Mallinckrodt Baker B.V. 7400 AA Deventer Holland) were dissolved in succession with stirring in the initially charged water having a temperature of 90° C. to give a clear, yellow solution. The solution was stirred at a temperature of 90° C. for 15 hours (pH=8.0). The solution was spray dried using air (inlet temperature=330° C., outlet temperature=107° C.) in a spray drier (model: Mobile Minor™ 2000, MM, manufacturer: Niro A/S, 2860 SØborg, Denmark).

50 g of the light-brown spray-dried powder obtained were heated to 300° C. under a stream of air (10 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

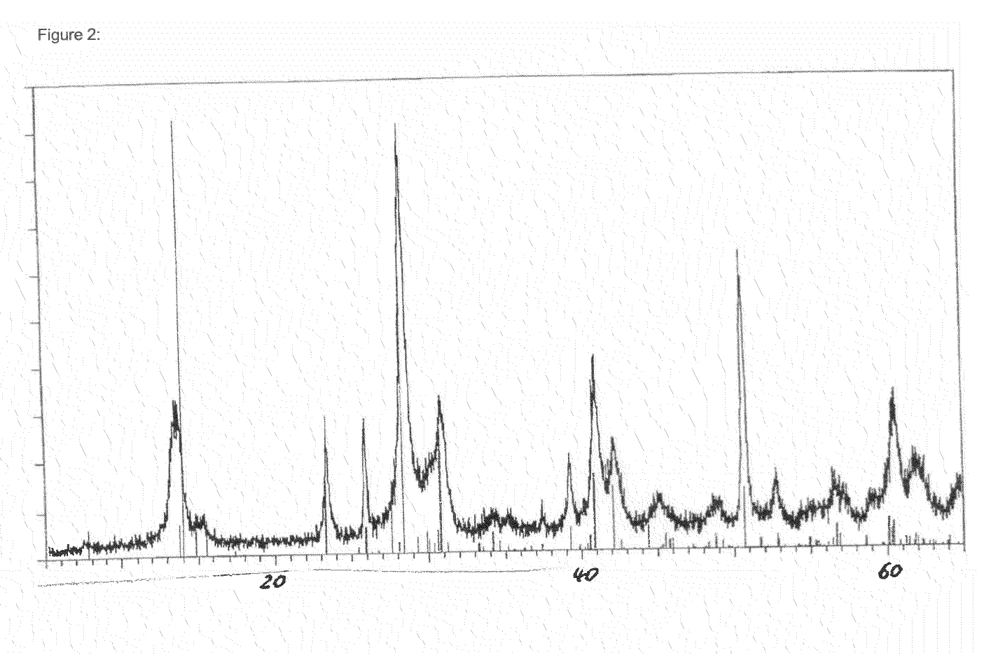

The dark brown powder obtained had a specific surface area of 17.1 m²/g. The powder diffraction pattern recorded using Cu—Kα radiation shows the presence of a phase isostructural with LiV₃O₈ (see FIG. 2).

### EXAMPLE 3

### Preparation of Li_{1.0}K_{0.1}V₃O₈

7.0 l of distilled water were heated to 90° C. in a 10 l stirred glass vessel equipped with a heatable double wall. 351.26 g of ammonium metavanadate NH₄VO₃ (99.9% by weight pure; corresponding to 3 mol) and 42.62 g of lithium hydroxide LiOH.H₂O (having a content of 55.5% by weight; 1.0 mol) and 6.6 g of potassium hydroxide KOH (0.1 mol, 85% strength by weight; supplier: Sigma-Aldrich GmbH, 30926 Seelze) were dissolved in succession with stirring in the initially charged water having a temperature of 90° C. to give a clear, yellow solution. The solution was stirred at a temperature of 90° C. for 15 hours (pH=8.0). The solution was spray dried using air (inlet temperature=330° C., outlet temperature=107° C.) in a spray drier (model: Mobile Minor™ 2000, MM, manufacturer: Niro NS, 2860 SØborg, Denmark).

50 g of the light-brown spray-dried powder obtained were heated to 300° C. under a stream of air (10 standard l/h) in a continuously rotating (8 revolutions per minute (rpm)) fused silica ball having an internal volume of 1 l and were then maintained at this temperature for 1 hour. The product was subsequently cooled to room temperature with ongoing rotation of the fused silica ball.

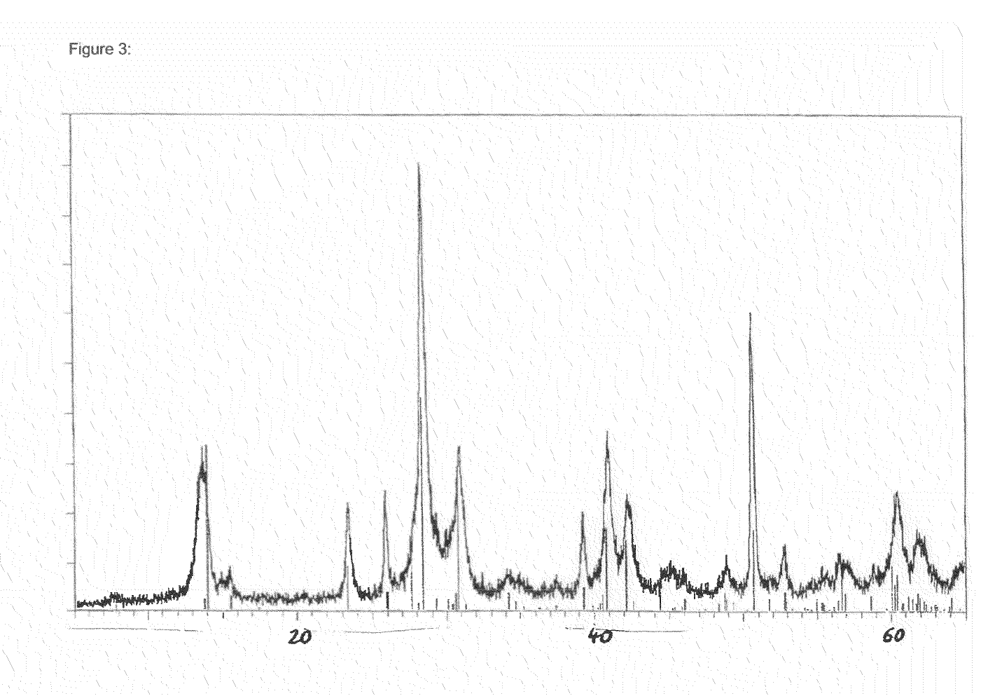

The dark brown powder obtained had a specific surface area of 14.9 m²/g. The powder diffraction pattern recorded using Cu—Kα radiation shows the presence of a phase isostructural with LiV₃O₈ (see FIG. 3).

### EXAMPLE 4

The preparation was carried out as in Example 1, but the calcination was carried out at a temperature of 585° C. The dark brown powder obtained had a specific surface area (measured by the BET method) of 1.8 m²/g.

The powder diffraction pattern recorded using Cu—K_{α} radiation shows the presence of monoclinic LiV₃O₈ (JCDD card index No. 01-072-1193). The SEM (scanning electron microscopy) image shows board-shaped crystals having a board length of about 10-20 microns. The width of the boards was about 1-4 microns and the thickness of the boards was about 0.5-2 microns.

### EXAMPLE 5

### Production of an Electrochemical Cell and Electrochemical Characterization

To prepare a cathode, 5.0 g of the Li_{1.1}V₃O₈ powder prepared in Example 1 were mixed with 0.43 g of graphite powder (Timrex® KS 4, from Timcal AG, 6743 Bodio, Switzerland), 0.08 g of carbon black (Super P®, from Timcal AG, 6743 Bodio, Switzerland), 6.5 g of the solvent Decan (from Sigma-Aldrich Chemie GmbH, CH-9571 Buchs SG, Switzerland) and 0.29 g of the binder polyisobutene Oppanol® (grade B200, from BASF Aktiengesellschaft, 67056 Ludwigshafen) for 30 seconds by means of a high-speed stirrer (Ultra-Turrax® T25 basic, from IKA Labortechnik, D-79219 Staufen).

The black suspension obtained was degassed in a closed glass container on rollers and subsequently applied in a layer thickness of 250 μm to an aluminum foil by means of a doctor blade.

After drying at 80° C. in a vacuum drying oven for 1 hour, the applied layer thickness was 80 μm.

Electrodes having a diameter of 13 mm were stamped from the resulting cathode material and installed in cells in a glove box under argon (content of oxygen and water vapor in each case <1 ppm) for electrochemical characterization.

As anode, use was made of metallic lithium disks stamped from a 750 μm thick Li foil (from Sigma-Aldrich Chemie GmbH, CH-9571 Buchs SG, Switzerland).

A glass fiber nonwoven having a thickness of about 1 mm was used as separator and a mixture of dimethyl carbonate and ethylene carbonate in a ratio of 1:1 having a content of 1 mol/l of lithium hexafluorophosphate LiPF₆ (manufacturer: Ferro Corp., Cleveland, USA) was used as electrolyte solution.

To test the stability, the cell is installed in a measurement setup for electrochemical characterization and cycled using the following parameters:

1st cycle: discharge at 28 mA/g to a cell voltage of 2.2 V followed by a decrease in current at 2.2 V down to a current of less than 5.6 mA/g.

2nd to 7th cycle: charging at 28 mA/g to a cell voltage of 3.7 V followed by a reduction in current at 3.7 V down to a current of less than 2.8 mA/g and then discharge at 28 mA/g to a cell voltage of 2.2 V followed by a decrease in current at 2.2 V down to a current of less than 2.8 mA/g.

8th to 33rd cycle: charging at 93.3 mA/g to a cell voltage of 3.7 V and then discharge at 93.3 mA/g to a cell voltage of 2.2 V.

34th to 38th cycle: as 2nd to 7th cycle.

39th to 63rd cycle: as 8th to 33rd cycle.

The result of cycling is shown in FIG. 7.

It can be seen that a high specific capacity of the lithium vanadium oxide cathode is ensured. The electrochemical test cell constructed therefrom is cycle-stable.

Even at relatively high current densities, a high specific capacity of the lithium vanadium oxide cathode can be achieved.

### EXAMPLE 6

### Preparation of Li_{1.1}V₃O₈ Without Addition of Carbon, Dilute Mode of Operation

7.0 l of distilled water were heated to 90° C. in a 10 l stirred glass vessel equipped with a heatable double wall. 117.1 g of ammonium metavanadate (having a content of 99.9% by weight of NH₄VO₃, corresponding to 1 mol, supplier: GfE GmbH, D-90431 Nuremburg) and 15.32 g of lithium hydroxide monohydrate (having a content of 57.32% by weight of LiOH.H₂O; corresponding to 0.37 mol, supplier: Chemetall GmbH, D-60487 Frankfurt a.M.) were dissolved in succession with stirring in the initially charged water having a temperature of 90° C. to give a clear, yellow solution. The solution was stirred at a temperature of 90° C. for 15 hours (pH=8.0) and then spray dried using air (inlet temperature=330° C., outlet temperature=107° C.) in a spray drier (model: Mobile Minor™ 2000, MM, manufacturer: Niro A/S, 2860 SØborg, Denmark).

50 g of the light-brown spray-dried powder obtained were heated to 300° C. under a stream of air (15 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 14.0 m²/g. The powder diffraction pattern recorded using Cu—Kα radiation showed the presence of LiV₃O₈. As the scanning electron micrograph (SEM image) showed, the product comprised agglomerates made up of small grown-together primary particles and having an average agglomerate diameter of about 16 μm. The ammonium (NH₄) content of the product was 0.28% by weight and the carbon content was <0.01% by weight.

Calcination of the spray-dried powder under a stream of air (30 standard l/h) at 315° C. for one hour gave a product having a specific surface area of 15.7 m²/g. The ammonium (NH₄) content of the product was 0.10% by weight and the carbon content was <0.01% by weight.

### EXAMPLE 7

### Li_{1.1}V₃O₈ with 1.5% by Weight of Carbon Black and 7.8% by Weight of Graphite

7.0 l of distilled water were heated to 90° C. in a 10 l stirred glass vessel equipped with a heatable double wall. 351.3 g of ammonium metavanadate (having a content of 99.9% by weight of NH₄VO₃, corresponding to 3 mol, supplier: GfE GmbH, D-90431 Nuremburg) and 45.96 g of lithium hydroxide monohydrate (having a content of 57.32% by weight of LiOH.H₂O, corresponding to 1.1 mol, supplier: Chemetall GmbH, D-60487 Frankfurt a.M.) were dissolved in succession with stirring in the initially charged water having a temperature of 90° C. to give a clear, yellow solution A.

In a 2 l glass beaker, 200 g of hydrogen peroxide solution (having a content of 30% by weight of H₂O₂, corresponding to 1.76 mol, supplier: Merck, D-64295 Darmstadt), 4.60 g of carbon black (grade Super P® Li, supplier: Timcal AG, CH-6743 Bodio) and 24.74 g of graphite (grade Timrex® KS6 AB-198 M, supplier: Timcal AG, CH-6743 Bodio) were added in succession while stirring to 0.5 l of distilled water and the mixture was stirred at room temperature for 15 minutes. A black, aqueous suspension B was obtained.

The suspension B was then slowly added to the solution A having a temperature of 90° C. The resulting black suspension C was stirred at a temperature of 90° C. for a further 15 hours (pH=8.0) and spray dried using air (inlet temperature=330° C., outlet temperature=107° C.) in a spray drier (model Mobile Minor™ 2000, MM, manufacturer: Niro NS, 2860 SØborg, Denmark).

50 g of the light-brown spray-dried powder obtained were heated to 300° C. under a stream of air (15 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 13.0 m²/g. The powder diffraction pattern recorded using Cu—Kα radiation showed the presence of LiV₃O₈ and graphite. As the scanning electron micrograph (SEM image) showed, the product comprised agglomerates made up of small grown-together primary particles and having an average agglomerate diameter of about 20 μm. The ammonium (NH₄) content of the product was 0.19% by weight and the carbon content was 8.6% by weight.

Calcination of the spray-dried powder under a stream of air (45 standard l/h) at 315° C. for one hour gave a product having a specific surface area of 16.8 m²/g. The ammonium (NH₄) content of the product was 0.10% by weight and the carbon content was 8.9% by weight.

### EXAMPLE 8

### Li_{1.1}V₃O₈ with 1.5% by Weight of Carbon Black and 7.8% by Weight of Graphite, Dilute Mode of Operation

7.0 l of distilled water were heated to 90° C. in a 10 l stirred glass vessel equipped with a heatable double wall. 117.1 g of ammonium metavanadate (having a content of 99.9% by weight of NH₄VO₃, corresponding to 1 mol, supplier: GfE GmbH, D-90431 Nuremburg) and 15.32 g of lithium hydroxide monohydrate (having a content of 57.32% by weight of LiOH.H₂O, corresponding to 0.37 mol, supplier: Chemetall GmbH, D-60487 Frankfurt a.M.) were dissolved in succession with stirring in the initially charged water having a temperature of 90° C. to give a clear, yellow solution A.

In a 1 l glass beaker, 40 g of hydrogen peroxide solution (having a content of 30% by weight of H₂O₂, corresponding to 0.35 mol, supplier: Merck, D-64295 Darmstadt), 1.53 g of carbon black (grade Super P® Li, supplier: Timcal AG, CH-6743 Bodio) and 8.25 g of graphite (grade Timrex® KS6 AB-198 M, supplier: Timcal AG, CH-6743 Bodio) were added in succession while stirring to 0.3 l of distilled water and the mixture was stirred at room temperature for 15 minutes. A black, aqueous suspension B was obtained.

The suspension B was then slowly added to the solution A having a temperature of 90° C. The resulting black suspension C was stirred at a temperature of 90° C. for a further 15 hours (pH=8.0) and spray dried using air (inlet temperature=330° C., outlet temperature=107° C.) in a spray drier (model Mobile Minor™ 2000, MM, manufacturer: Niro A/S, 2860 SØborg, Denmark).

50 g of the spray-dried powder obtained were heated to 300° C. under a stream of air (20 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 13.4 m²/g. The powder diffraction pattern recorded using Cu—Kα radiation showed the presence of LiV₃O₈ and graphite. As the scanning electron micrograph (SEM image) showed, the product comprised agglomerates made up of small grown-together primary particles and having an average agglomerate diameter of about 20 μm. The ammonium (NH₄) content of the product was 0.19% by weight and the carbon content was 8.8% by weight.

Calcination of the spray-drying powder under a stream of air (45 standard l/h) at 315° C. for one hour gave a product having a specific surface area of 15.2 m²/g. The ammonium (NH₄) content of the product was 0.08% by weight and the carbon content was 8.5% by weight.

### EXAMPLE 9

### Li_{1.1}V₃O₈ with 3.1% by Weight of Carbon Black

7.0 l of distilled water were heated to 90° C. in a 10 l stirred glass vessel equipped with a heatable double wall. 351.3 g of ammonium metavanadate (having a content of 99.9% by weight of NH₄VO₃, corresponding to 3 mol, supplier: GfE GmbH, D-90431 Nuremburg) and 45.96 g of lithium hydroxide monohydrate (having a content of 57.32% by weight of LiOH.H₂O, corresponding to 1.1 mol, supplier: Chemetall GmbH, D-60487 Frankfurt a.M.) were dissolved in succession with stirring in the initially charged water having a temperature of 90° C. to give a clear, yellow solution A.

In a 2 l glass beaker, 500 g of hydrogen peroxide solution (having a content of 30% by weight of H₂O₂, corresponding to 4.41 mol, supplier: Merck, D-64295 Darmstadt) and 9.2 g of carbon black (grade Super P® Li, supplier: Timcal AG, CH-6743 Bodio) were added in succession while stirring to 0.8 l of distilled water and the mixture was stirred at room temperature for 15 minutes. A black, aqueous suspension B was obtained.

The suspension B was then slowly added to the solution A having a temperature of 90° C. The resulting black suspension C was stirred at a temperature of 90° C. for a further 15 hours (pH=8.0) and spray dried using air (inlet temperature=330° C., outlet temperature=107° C.) in a spray drier (model Mobile Minor™ 2000, MM, manufacturer: Niro NS, 2860 SØborg, Denmark).

50 g of the spray-dried powder obtained were heated to 300° C. under a stream of air (20 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 16.4 m²/g. The powder diffraction pattern recorded using Cu—Kα radiation showed the presence of LiV₃O₈. As the scanning electron micrograph (SEM image) showed, the product comprised agglomerates made up of small grown-together primary particles and having an average agglomerate diameter of about 20 μm. The ammonium (NH₄) content of the product was 0.22% by weight and the carbon content was 2.9% by weight.

Calcination of the spray-dried powder under a stream of air (45 standard l/h) at 315° C. for one hour gave a product having a specific surface area of 16.6 m²/g. The ammonium (NH₄) content of the product was 0.03% by weight and the carbon content was 2.8% by weight.

### EXAMPLE 10

### Li_{1.1}V₃O₈ with 6.0% by Weight of Carbon Black

7.0 l of distilled water were heated to 90° C. in a 10 l stirred glass vessel equipped with a heatable double wall. 351.3 g of ammonium metavanadate (having a content of 99.9% by weight of NH₄VO₃, corresponding to 3 mol, supplier: GfE GmbH, D-60487 Frankfurt a.M.) and 45.96 g of lithium hydroxide monohydrate (having a content of 57.32% by weight of LiOH.H₂O, corresponding to 1.1 mol, supplier: Chemetall GmbH, D-90431 Nuremberg) were dissolved in succession with stirring in the initially charged water having a temperature of 90° C. to give a clear, yellow solution A.

In a 2 l glass beaker, 140 g of hydrogen peroxide solution (having a content of 30% by weight of H₂O₂, corresponding to 1.24 mol, supplier: Merck, D-64295 Darmstadt) and 18.4 g of carbon black (grade Super P® Li, supplier: Timcal AG, CH-6743 Bodio) were added in succession while stirring to 0.8 l of distilled water and the mixture was stirred at room temperature for 15 minutes. A black, aqueous suspension B was obtained.

The suspension B was then slowly added to the solution A having a temperature of 90° C. The resulting black suspension C was stirred at a temperature of 90° C. for a further 15 hours (pH=8.0) and spray dried using air (inlet temperature=330° C., outlet temperature=107° C.) in a spray drier (model Mobile Minor™ 2000, MM, manufacturer: Niro A/S, 2860 SØborg, Denmark).

50 g of the spray-dried powder obtained were heated to 300° C. under a stream of air (15 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 17.3 m²/g. The powder diffraction pattern recorded using Cu—Kα radiation shows the presence of LiV₃O₈. As the scanning electron micrograph (SEM image) showed, the product comprised agglomerates made up of small grown-together primary particles and having an average agglomerate diameter of about 20 μm. The ammonium (NH₄) content of the product was 0.21% by weight and the carbon content was 5.7% by weight.

Calcination of the spray-dried powder under a stream of air (45 standard I/h) at 315° C. for one hour gave a product having a specific surface area of 19.4 m²/g. The ammonium (NH₄) content of the product was 0.06% by weight and the carbon content was 5.8% by weight.

### EXAMPLE 11

### Li_{1.1}V₃O₈ with 1.0% by Weight of CNT (Carbon Nanotubes)

7.0 l of distilled water were heated to 90° C. in a 10 l stirred glass vessel equipped with a heatable double wall. 351.3 g of ammonium metavanadate (having a content of 99.9% by weight of NH₄VO₃, corresponding to 3 mol, supplier: GfE GmbH, D-90431 Nuremburg) and 45.96 g of lithium hydroxide monohydrate (having a content of 57.32% by weight of LiOH.H₂O, corresponding to 1.1 mol, supplier: Chemetall GmbH, D-60487 Frankfurt a.M.) were dissolved in succession with stirring in the initially charged water having a temperature of 90° C. to give a clear, yellow solution A.

In a 2 l glass beaker, 500 g of hydrogen peroxide solution (having a content of 30% by weight of H₂O₂, corresponding to 4.41 mol, supplier: Merck, D-64295 Darmstadt) 3.0 g of carbon nanotubes (CNT) (Nanocyl 7000, supplier: Nanocyl S.A., B-5060 Sambreville) and 9.2 g of carbon black (grade Super P® Li, supplier: Timcal AG, CH-6743 Bodio) were added in succession while stirring to 0.8 l of distilled water and the mixture was stirred at room temperature for 15 minutes. A black, aqueous suspension B was obtained.

The suspension B was then slowly added to the solution A having a temperature of 90° C. The resulting black suspension C was stirred at a temperature of 90° C. for a further 15 hours (pH=8.0) and spray dried using air (inlet temperature=330° C., outlet temperature=107° C.) in a spray drier (model Mobile Minor™ 2000, MM, manufacturer: Niro A/S, 2860 SØborg, Denmark).

50 g of the spray-dried powder obtained were heated to 300° C. under a stream of air (20 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 15.3 m²/g. The powder diffraction pattern recorded using Cu—Kα radiation shows the presence of LiV₃O₈. As the scanning electron micrograph (SEM image) shows, the product comprised agglomerates made up of small grown-together primary particles and having an average agglomerate diameter of about 20 μm. The ammonium (NH₄) content of the product was 0.23% by weight.

Calcination of the spray-dried powder under a stream of air (45 standard l/h) at 315° C. for one hour gave a product having a specific surface area of 17.4 m²/g. The ammonium (NH₄) content of the product was 0.07% by weight.

### EXAMPLE 12

### Electrochemical Characterization, Material from Example 6

To prepare a cathode, 5.0 g of the Li_{1.1}V₃O₈ powder prepared in Example 6 were mixed with 0.55 g of carbon black (Super P®, from Timcal AG, 6743 Bodio, Switzerland), 6.5 g of acetonitrile, 0.13 g of a copolymer PVdF-HFP comprising 12% by weight of HFP (Kynar® 2821, from Arkema) and 0.13 g of PEO having a molar mass of 300 000 g/mol for 30 seconds by means of a high-speed stirrer (Ultra-Turrax® T25 basic, from IKA Labortechnik, D-79219 Staufen). The black suspension obtained was degassed in a closed glass container on rollers and subsequently applied in a layer thickness of 250 μm to an aluminum foil by means of a doctor blade. After drying at 80° C. in a vacuum drying oven for 1 hour, the applied layer thickness was 80 μm. Electrodes having a diameter of 13 mm were stamped from the resulting cathode material and installed in cells in a glove box under argon (content of oxygen and water vapor in each case <1 ppm) for electrochemical characterization. As anode, use was made of metallic lithium disks stamped from a 750 μm thick Li foil (from Sigma-Aldrich Chemie GmbH, CH-9571 Buchs SG, Switzerland). A glass fiber nonwoven having a thickness of about 1 mm was used as separator and a mixture of dimethyl carbonate and ethylene carbonate in a ratio of 1:1 having a content of 1 mol/l of lithium hexafluorophosphate LiPF₆ (manufacturer: Ferro Corp., Cleveland, USA) was used as electrolyte solution.

The cell is installed in a measurement setup for electrochemical characterization and cycled using the following parameters:

Discharge at 117 mA/g to a cell voltage of 2.0 V followed by a decrease in current at 2.0 V down to a current of less than 7 mA/g.

Discharge at 117 mA/g to a cell voltage of 3.3 V followed by a decrease in current at 3.3 V down to a current of less than 7 mA/g.

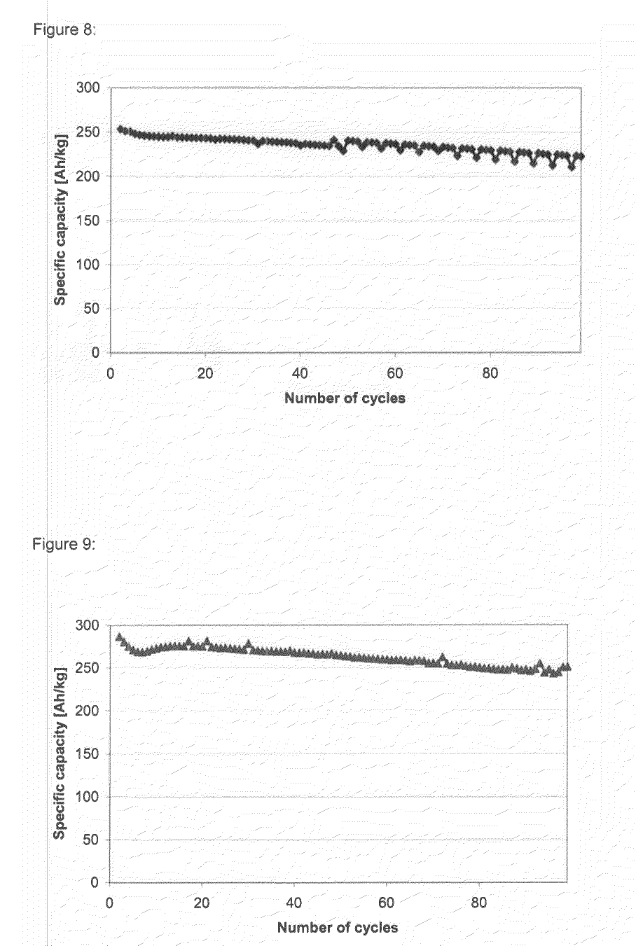

The result of the cycling is shown in FIG. 8.

### EXAMPLE 13

### Electrochemical Characterization, Material from Example 7

To prepare a cathode, 5.0 g of the Li_{1.1}V₃O₈ powder prepared in Example 7 were mixed with 0.55 g of carbon black (Super P®, from Timcal AG, 6743 Bodio, Switzerland), 6.5 g of acetonitrile, 0.13 g of a copolymer PVdF-HFP comprising 12% by weight of HFP (Kynar® 2821, from Arkema) and 0.13 g of PEO having a molar mass of 300 000 g/mol for 30 seconds by means of a high-speed stirrer (Ultra-Turrax® T25 basic, from IKA Labortechnik, D-79219 Staufen). The black suspension obtained was degassed in a closed glass container on rollers and subsequently applied in a layer thickness of 250 μm to an aluminum foil by means of a doctor blade. After drying at 80° C. in a vacuum drying oven for 1 hour, the applied layer thickness was 80 μm. Electrodes having a diameter of 13 mm were stamped from the resulting cathode material and installed in cells in a glove box under argon (content of oxygen and water vapor in each case <1 ppm) for electrochemical characterization. As anode, use was made of metallic lithium disks stamped from a 750 μm thick Li foil (from Sigma-Aldrich Chemie GmbH, CH-9571 Buchs SG, Switzerland). A glass fiber nonwoven having a thickness of about 1 mm was used as separator and a mixture of dimethyl carbonate and ethylene carbonate in a ratio of 1:1 having a content of 1 mol/I of lithium hexafluorophosphate LiPF₆ (manufacturer: Ferro Corp., Cleveland, USA) was used as electrolyte solution.

The cell is installed in a measurement setup for electrochemical characterization and cycled using the following parameters:

Discharge at 117 mA/g to a cell voltage of 2.0 V followed by a decrease in current at 2.0 V down to a current of less than 7 mA/g.

Discharge at 117 mA/g to a cell voltage of 3.3 V followed by a decrease in current at 3.3 V down to a current of less than 7 mA/g.

The result of the cycling is shown in FIG. 9.

### EXAMPLE 14

### Preparation of Li_{1.1}V₃O₈ Without Addition of Carbon, Concentrated Mode of Operation

3.5 l of distilled water were heated to 90° C. in a 5 l stirred glass vessel equipped with a heatable double wall. 351.3 g of ammonium metavanadate (having a content of 99.9% by weight of NH₄VO₃, corresponding to 3 mol, supplier: GfE GmbH, D-90431 Nuremburg) and 45.96 g of lithium hydroxide monohydrate (having a content of 57.32% by weight of LiOH.H₂O; corresponding to 1.1 mol, supplier: Chemetall GmbH, D-60487 Frankfurt a.M.) were dissolved in succession with stirring in the initially charged water having a temperature of 90° C. to give a clear, yellow solution. The solution was stirred at a temperature of 90° C. for 15 hours (pH=8.0) and then spray dried using air (inlet temperature=330° C., outlet temperature=107° C.) in a spray drier (model: Mobile Mknorm™ 2000, MM, manufacturer: Niro NS, 2860 SØborg, Denmark).

50 g of the spray-dried powder obtained were heated to 300° C. under a stream of air (15 standard l/h) in a continuously rotating (8 revolutions per minute) fused silica ball having an internal volume of 1 l and were then maintained at this temperature for 1 hour. The product was subsequently cooled to room temperature with ongoing rotation of the fused silica ball.

The powder obtained had a specific surface area (measured by the BET method) of 13.0 m²/g. The powder diffraction pattern recorded using Cu—Kα radiation showed the presence of LiV₃O₃. As the scanning electron micrograph (SEM image) showed, the product comprised agglomerates made up of small grown-together primary particles and having an average agglomerate diameter of about 26 μm. The ammonium (NH₄) content of the product was 0.38% by weight and the carbon content was <0.01% by weight.

Calcination of the spray-dried powder under a stream of air (45 standard l/h) at 315° C. for one hour gave a product having a specific surface area of 15.3 m²/g. The ammonium (NH₄) content of the product was 0.09% by weight and the carbon content was <0.01% by weight.

1. A process for preparing a lithium vanadium oxide, comprising:
a) producing a solution or suspension from water, at least one water-soluble lithium salt, at least one water-soluble vanadium compound and, optionally, further components, with it also being possible for at least the lithium salt and the vanadium compound to be present in completely dissolved form in the suspension,
b) drying of the solution or suspension to obtain a solid, and
c) calcinating the solid.

2. The process according to claim 1, wherein the solution is produced from water, lithium hydroxide and ammonium metavanadate and, optionally, water-soluble components.

3. The process according to claim 1, wherein the solution is a clear solution produced from water, 0.05-0.5 mol/l of lithium hydroxide and 0.1-1.3 mol/l of ammonium metavanadate and, optionally, further water-soluble components.

4. The process according to claim 1, wherein the drying is spray drying, freeze drying or freeze-spray drying.

5. The process according to claim 1 wherein the solution or suspension is subjected directly to a spray-drying process at a temperature of from 100 to 450° C. using air or nitrogen.

6. The process according to claim 1, wherein the solution or suspension is subjected directly to a freeze drying process.

7. The process according to claim 1, wherein the calcination is carried out at a temperature of from 250 to 600° C.

8. A lithium vanadium oxide which can be prepared according to the process of claim 1 and has a specific surface area of from 0.5 to 50 m²/g.

9. The lithium vanadium oxide according to claim 8 which forms spherical aggregates having a diameter of from 5 μm to 500 μm.

10. The lithium vanadium oxide according to claim 8 which has a composition corresponding to the formula Li₁₊ₓV₃O₈, where x is from 0 to 0.6.

11. The lithium vanadium oxide according to claim 8 which has a composition corresponding to the formula Li_{1+x-y}M_{y}V₃O₈, where x is from 0 to 0.6, M is sodium, potassium, rubidium or cesium and y is from 0.05 to 0.5.

12. The lithium vanadium oxide according to claim 8 which has no distinct line in the 2 theta range from 27 to 28 degrees in an X-ray diffraction pattern recorded by means of copper K_{α} radiation.

13. (canceled)

14. A cathode for a lithium ion battery, which comprises a lithium vanadium oxide according to claim 8.

15. A process for producing a mixture of a lithium vanadium oxide and at least one electrically conductive material, comprising:
d) producing a solution or suspension from water, at least one water-soluble lithium salt, at least one water-soluble vanadium compound, optionally further components and at least one electrically conductive material, wherein the lithium salt and/or the vanadium compound are optionally present in completely dissolved form in the suspension,
e) drying of the solution or suspension to produce a solid, and
f) calcinating the solid.

16. The process according to claim 15, wherein the solution or suspension is produced from water, lithium hydroxide, ammonium metavanadate, optionally further components and at least one electrically conductive material.

17. The process according to claim 15, wherein the solution is a clear solution produced from water, 0.05-0.5 mol/l of lithium hydroxide, 0.1-1.3 mol/l of ammonium metavanadate, optionally further components and at least one electrically conductive material.

18. The process according to claim 15, wherein the electrically conductive material is carbon black, graphite, carbon fibers, carbon nanofibers, carbon nanotubes or electrically conductive polymers.

19. The process according to claim 15, wherein the drying is spray drying, freeze drying or freeze spray drying.

20. The process according to claim 15, wherein the solution or suspension is subjected directly to a spray-drying process at a temperature of from 100 to 450° C. using air or nitrogen.

21. The process according to claim 15, wherein the solution or suspension produced is subjected directly to a freeze-drying process.

22. The process according to claim 15, wherein the calcination is carried out at a temperature of from 250 to 600° C.

23. A mixture of a lithium vanadium oxide and at least one electrically conductive material, which can be produced according to claim 15 and has a specific surface area of from 0.5 to 50 m²/g.

24. The mixture of a lithium vanadium oxide and at least one electrically conductive material according to claim 23 which forms spherical aggregates having a diameter of from 5 μm to 500 μm.

25. The mixture of a lithium vanadium oxide and at least one electrically conductive material according to claim 23, wherein the lithium vanadium oxide has a composition corresponding to the formula Li₁₊ₓV₃O₈, where x is from 0 to 0.6.

26. The mixture of a lithium vanadium oxide and at least one electrically conductive material according to claim 23, wherein the lithium vanadium oxide has a composition corresponding to the formula Li_{1+x-y}M_{y}V₃O₈, where x is from 0 to 0.6, M is sodium, potassium, rubidium or cesium and y is from 0.05 to 0.5.

27. (canceled)

28. A cathode for a lithium ion battery, which comprises a mixture of a lithium vanadium oxide and at least one electrically conductive material according to any of claim 23.
